(19) United States
(12) Patent Application Publication
(10) Pub. No.: US 2013/0035799 A1
(43) Pub. Date: Feb. 7, 2013

(54) METHOD AND SYSTEM FOR ENERGY EFFICIENT COLLABORATIVE HIGH PERFORMANCE BUILDING CONTROL

(71) Applicants: Zhen Song, Plainsboro, NJ (US); Xianjun S. Zheng, Plainsboro, NJ (US)

(72) Inventors: Zhen Song, Plainsboro, NJ (US); Xianjun S. Zheng, Plainsboro, NJ (US)

(73) Assignee: Siemens Corporation, Iselin, NJ (US)

(21) Appl. No.: 13/560,186

(22) Filed: Jul. 27, 2012

Related U.S. Application Data
(60) Provisional application No. 61/514,141, filed on Aug. 2, 2011.

(51) Int. Cl. G06F 1/28

(52) U.S. Cl. 700/291

(57) ABSTRACT

A method and system for enabling facility managers and occupants of commercial buildings to collaboratively define energy policy for building energy control is disclosed.

This application claims the benefit of U.S. Provisional Application No. 61/514,141, filed Aug. 2, 2011, the disclosure of which is herein incorporated by reference.

### BACKGROUND OF THE INVENTION

For commercial buildings, energy related control policies, such as heating, ventilation, and air conditioning (HVAC) or lighting schedule control policies, and set points are typically defined and imposed by facility managers. Occupants, who are the end users of the building, generally have no opportunity to contribute the definition of control policies or have limited methods to communicate with facility managers or other occupants for their specific needs or preferences. This one-way, top-down process of policy definition often results in two consequences. On one hand, facility managers who have stringent energy policies to achieve energy saving goals often need to sacrifice occupants' comfort; on the other hand, those who relax the energy policies to avoid occupant complaints often miss the opportunity for energy saving. Several studies show that building control policies, taking into consideration of occupants' activities and needs, have potentials to significantly optimize energy saving and also to improve occupants' experience. However, currently there are no systematic approaches or tools that can facilitate the communications and collaborations between occupants and facility managers, and occupants themselves.

Building Automation Systems (BASs) typically rely on direct human-to-human communication to define energy policy. There are no commercial systems to facilitate the communication between occupants and facility managers. For example, for lighting systems, occupants and facility managers have predefined authority. The occupants can turn on and off lights while the facility managers can adjust dimming. There is no communication between the two. That is, facility managers do not consider occupants' inputs while defining the energy policies. In another example, for thermal systems, occupants' behaviors are regulated by an energy bidding systems so facility managers are not involved in the process.

In all the existing systems suited for commercial buildings, facility managers are the only people who define energy policy and arbitrate conflictive occupant requirements. Occupants are assigned a very limited freedom to define and regulate energy policy.

### BRIEF SUMMARY OF THE INVENTION

The present invention provides a method and system for energy efficient building control for commercial buildings. Embodiments of the present invention utilize a collaborative and distributed approach in defining and maintaining energy policy that ensures occupants' comfort while maintaining efficient energy consumption.

In one embodiment, a method for energy efficient collaborative high performance building control includes receiving from a first user at least one energy consumption requirement, determining whether at least one energy consumption requirement conflicts with an energy consumption ruleset, determining whether at least one energy consumption requirement conflicts with another energy consumption requirement received from a second user, and simulating the at least one energy consumption requirement.

These and other advantages of the invention will be apparent to those of ordinary skill in the art by reference to the following detailed description and the accompanying drawings.

### BRIEF DESCRIPTION OF THE DRAWINGS

FIG. 1 illustrates an exemplary system for energy efficient collaborative high performance building control;

FIG. 2 illustrates an exemplary method for energy efficient collaborative high performance building control;

FIG. 3 illustrates a method for resolving conflicts between an energy consumption requirements and an energy consumption policy in order to determine an optimal efficiency energy policy;

FIG. 4 illustrates a method for resolving conflicts between energy consumption requirements received by different occupants in order to determined an optimal efficiency energy policy;

FIG. 5 illustratively depicts components of a computer that may be used to implement the invention.

### DETAILED DESCRIPTION

The present invention provides a method and system for energy efficient building control for commercial buildings. Embodiments of the present invention provide for a method and system that allows facility managers and occupants to collaboratively define energy policy for building energy control. The Collaborative Building Control (CBC) system collects energy consumption requirements as inputs from occupants and facility managers, resolves conflictive requirements, and provides detailed commands to a Building Automation System (BAS), in order to optimize energy usage.

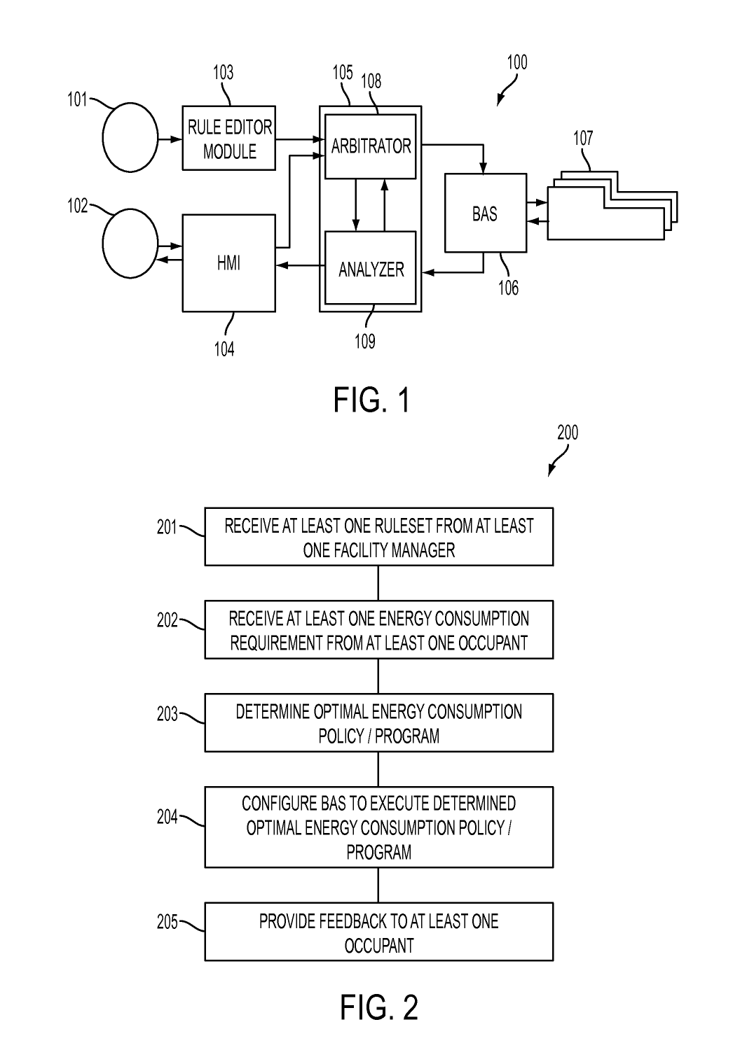

FIG. 1 illustrates an exemplary CBC system 100 for energy efficient collaborative high performance building control. System 100 includes at least one rule editor module 103, at least one human-to-machine interface 104, and a simulation-enabled analytical engine 105 configured and operable to communicate with a Building Automation System (BAS) 106 of at least one building 107.

According to an advantageous embodiment of the present invention, energy consumption rules are entered into the analytical engine 105 through the rule editor module 103. The rule editor module 103 may be implemented using a user-friendly graphical user interface. This user-friendly graphical user interface may include a plurality of fields to be filled by a facility manager 101 in order to enter energy consumption rules. Also, the rule editor module 103 may provide the facility manager 101 with visual feedback about the entered energy consumption rules.

In an embodiment of the present invention, energy consumption rules are formulated as a combination of Finite State Machine (FSM) and one of a plurality of sequential programming languages. In an advantageous embodiment, a Collaborative Rule Engine is created to accept one of a markup programming languages (e.g., SCXML) in combination with a general purpose sequential programming language (e.g., C#) in the energy consumption rule files, which may be received from either facility managers or occupants. The energy consumption rule files may be created and edited with the use of a graphical programming tool created for the Collaborative Rule Engine. It is to be understood that the Collaborative Rule Engine is not limited to any particular markup language as it may utilize a wide variety of markup languages for FSMs, including VoiceXML, XPDL, etc. It is also understood that the Collaborative Rule Engine is not limited to any particular sequential programming language as may also utilize a large number of sequential programming languages, such as Python, C++, Java, Javascript, Jscript, Actionscipt, Objective-C, BASIC, Visual BASIC, Delphi, ADA, Fortran, LISP, Prolog, PHP, F#, Erlang, J#, Ruby, COBRA, Matlab, R, Scilab, Perl, etc.

The human-to-machine interface (HMI) 104 may be used by occupants 102 to submit energy consumption requirements to the analytical engine 105 and receive feedback about submitted energy consumption requirements. The feedback may include the economic consequences resulting from implementing the energy consumption requirements, as calculated by the simulation-enabled analytical engine 105 of system 100. The HMI 104 may be a graphical user interface including a plurality of modifiable fields allowing occupants 102 to modify such parameters as temperature, humidity, and lighting. In an advantageous embodiment, the HMI 104 also includes access to a social network in which the occupant 102 is a member. Access to social network through the HMI 104 enables occupants 102 to communicate with other occupants 102 in order to resolve reported conflicts among submitted energy consumption requirements. Access to the social network through the HMI 104 also enables the occupant 102 to share with the occupant's social network contacts useful tips on how to optimize energy consumption. Such access allows the occupant 102 to share his/her experience in optimizing energy consumption with his/her social network contacts.

In an embodiment of the present invention, occupants 102 may submit complex hybrid energy consumption requirements that schedule a variety of requests directed at certain range of temperature, humidity, and lighting depending on certain period of time.

One skilled in the art will recognize that configuration HMI, as described above, is non-limiting and that its components may be combined in any way in various embodiments and may include any additional and/or desired components and/or configurations.

In addition to HMI, occupants may interact with system 100 of FIG. 1 through one or more social networks, according to an embodiment of the present invention.

According to an advantageous embodiment of the present invention, the simulation-enabled analytical engine 105 includes Arbitrator module 108 and Analyzer module 109. The inputs to the Arbitrator module 108 include the energy consumption rules defined by the facility manager 101 and entered through the rule editor module 103. Also, the inputs to the Arbitrator module include the energy consumption requirements submitted by occupants 102 through the HMI 104. The core of the Arbitrator module 108 is a reasoning engine that can verify if the energy consumption requirements satisfy the energy consumption rules or if the energy consumption requirements and the energy consumption rules have conflicts. Model-based simulation is used by the Arbitrator module of the analytical engine 105. If different occupants have conflicting energy consumption requirements or energy requirements that conflict with the energy consumption rules, the Arbitrator module 108 can interact, through the HMI 104, with occupants in order to resolve all conflicts between the energy consumption requirements while enforcing the energy consumption rules provided by the facility manager 101. The Arbitrator module 108 can automatically make decisions regarding conflicting conflict requests according to specifications defined by the facility manager 101 in the energy consumption rules. Once conflicts are resolved, the Arbitrator module 108 adjusts the control set points and schedules in the BAS. In an embodiment of the present invention, the Analyzer module 109 can estimate energy usage for each individual occupant. After receiving occupants' energy consumption requirements, the Analyzer module simulates the implementation of the energy consumption requirements by the BAS 106 in the building 107 in order to determine an estimate of energy costs due to the energy consumption requirement and provides the estimated cost for energy usage to the occupant 102 who input the energy consumption requirement. Therefore, occupants 102 may adjust their energy consumption requirements accordingly. The Analyzer module 109 can also simulate energy consumption with resulting from varying an input energy consumption requirement in order to provide an occupant 102 with suggestions for revising the energy consumption requirement to conserve energy. Analyzer module 109 also tracks individual occupant energy usage with logged data and provides feedback to occupants 102 and the facility manager 101. Upon confirming that there are no conflicts between the energy consumption rules or if the energy consumption requirements, the analytical engine 105 transmits necessary adjustment commands to the BAS 106 which, in turn, adjusts controls in order to satisfy the submitted energy consumption requirements.

In an embodiment of the present invention, the analytical engine 105 may be implemented using one or more computers. Specifically, the analytical engine 105 contains at least one processor which controls the overall operation of the analytical engine 105 by executing computer program instructions which define such operation. The computer program instructions may be stored in a storage device, or other computer readable medium, (e.g., magnetic disk) and loaded into a memory of the analytical engine 105 when execution of the computer program instructions is desired. By executing such computer program instructions, the processor of the analytical engine 105 controls the rule editor module 103, the HMI 104, the Arbitrator module 108, and the Analyzer module 109.

It is recognized that the BAS 106 may be any Building Automation System integrated into any commercial building 107. The BAS 106 can include one or more controls configured to control various aspects of the building 107, such as HVAC, ventilation, plug load control, daylighting control, heat from electric lights, moisture management, heat recovery, displacement ventilation, natural ventilation, etc.

One skilled in the art will recognize that the system configuration of FIG. 1 is non-limiting and that components of the presented system may be combined in any way in various embodiments and may include any additional and/or desired components and/or configurations.

FIG. 2 illustrates an exemplary method 200 for energy efficient collaborative high performance building control, according to an embodiment of the present invention.

At step 201, energy consumption rules are received from a facility manager. In an advantageous embodiment, the energy consumption rules are defined by the facility manager and may include one or more building-wide energy policies and settings. The building-wide energy settings may include time limits for initiating or terminating pre-defined energy policies, heating, cooling, and lighting metrics. The building-wide energy policies may include rules for resolving potential conflicts between contradictory requirements received from occupants. In an embodiment of the present invention, the energy consumption rules are received from a facility manager through the rule editor module 103 of FIG. 1.

At step 202, energy consumption requirements are received from occupants of the building. In an advantageous embodiment, an energy consumption requirement is defined by an occupant and reflects energy consumption needs of that occupant. Examples of energy consumption needs include, but are not limited to: desired temperature of the occupant's facility, the duration/schedule during which desired temperature is to be maintained by BAS, desired lighting, and the duration/schedule during which the desired lighting (e.g., dimming, window blinds' control, etc.) is to be maintained. In an embodiment of the present invention, the energy consumption requirements may be received from occupants by the system 100 of FIG. 1 through the HMI 104.

At step 203, an optimal energy consumption policy is determined based on the energy consumption requirements received from the occupants and based on the energy consumption rules received from the facility manager. In order to determine an optimal energy consumption policy, it is necessary to resolve a conflict between energy consumption requirements and the energy consumption rules and between energy consumption requirements of different occupants.

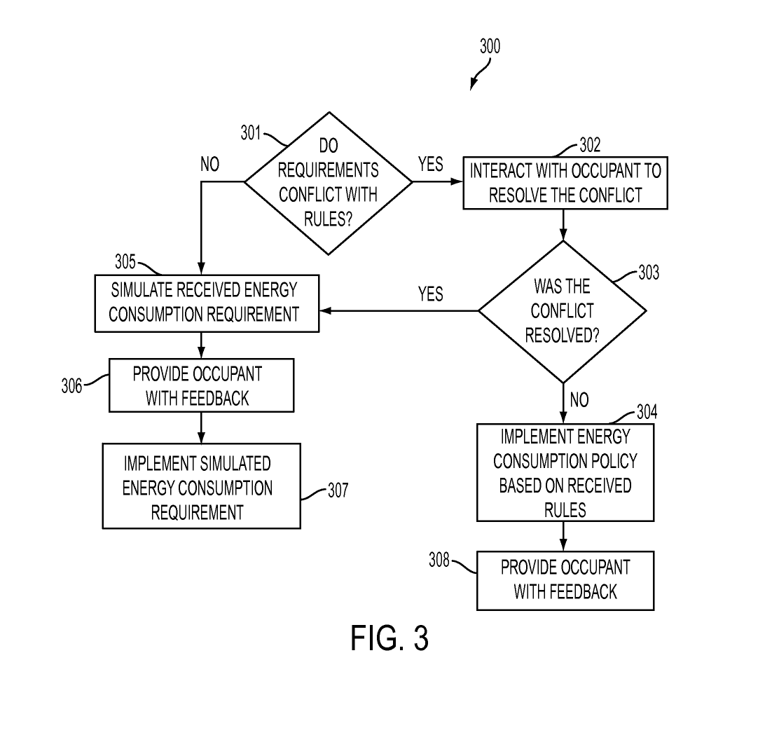

FIG. 3 illustrates an exemplary method 300 for determining the optimal energy consumption policy by resolving a conflict between the energy consumption rules and the energy consumption requirements, according to an embodiment of the present invention. The method of FIG. 3 can be used in the implementation step 203 of FIG. 2 in order to resolve a conflict between the energy consumption rules and an input energy consumption requirement.

At step 301, a determination is made whether the energy consumption requirement received from the occupant conflicts with the energy consumption rules received from the facility manager. If it is determined that the energy consumption requirement conflict with the energy consumption rules, the method 300 proceeds to step 302. If it is determined that the energy consumption requirements do not conflict with the energy consumption rules, the method 300 proceeds to step 305.

Upon determining that the energy consumption requirement conflicts with the energy consumption rule, at step 302, the occupant-originator of the energy consumption requirement is notified about the conflict through the HMI 104 of FIG. 1. In an embodiment of the present invention, the occupant may be notified about the conflict through a social networking site or through any other known information delivery channels (mobile phones, emails, etc.). When notified about the conflict, the occupant may be prompted, through the HMI 104, to modify the energy consumption requirement in order to resolve the conflict. It is recognized that the occupant may also enter a new energy consumption requirement or cancel the initial energy consumption requirement to resolve the conflict. At step 303, it is determined whether the conflict is resolved after the occupant was given the opportunity to resolve the conflict. If it is determined that the conflict was resolved, the process 300 proceeds to step 305. If it is determined that the conflict remains unresolved, the process 300 proceeds to step 304.

At step 305, the energy consumption policy is simulated to determine an economic consequence of the energy consumption policy being simulated. According to an advantageous embodiment, occupant's requests are simulated by energy simulation software such as EnergyPlus. It is to be understood that utilization of other energy simulation software, such as Trnsys, DOE2, Design Builder, SIMBAD, HAMLAB, BCVTB, Dymola, etc, is also possible. In an embodiment of the present invention, the estimated economic consequence of simulated energy consumption policy is determined for the occupant and for the building. One skilled in the art will recognize that the economic consequence may be quantified in estimated financial expenditures, estimated energy expenditures (e.g., KiloWatts (KW) for electricity, BTU for natural gas/propane, tons for coal, etc.), and ecological footprint, but the present invention is not intended thereto.

Upon determining, at step 305, the economic consequence of the energy consumption policy, the method 300 proceeds to step 306, at which the occupant-originator of the energy consumption requirement is provided with feedback in the form of data containing the economic consequence to the occupant. According to an advantageous embodiment, the feedback may include one or more suggestions to the occupant on how to further optimize energy consumption. It may be recognized that, upon receiving the feedback, the occupant may elect to further modify the energy consumption request to further optimize the energy consumption. In other words, the occupant may elect to compromise his/her comfort in favor of saving money and/or minimizing ecological footprint by reducing the energy expenditures.

At step 307, the energy consumption requirement is implemented at the BAS of the building. In particular, updated set points and schedules are sent to the BAS in order to control the BAS to implement the energy consumption requirement. According to an advantageous embodiment, implemented energy consumption policy is being continuously or periodically monitored and gathered data being provided to the occupant and to the facility manager.

If, at step 303, a determination is made that the conflict between the energy consumption requirement and energy consumption rule is not resolved, at step 304, the energy consumption policy is implemented at the BAS based the energy consumption rules provided by the facility manager. Then the method 300 proceeds to step 308, where the occupant-originator of the energy consumption requirement is provided with feedback. According to an embodiment, the feedback may include explanation why the occupant's energy consumption requirement was not implemented. The feedback may also a comparison of the economic benefit to the occupant from implementing the energy consumption rule over implementing the occupant's energy consumption requirement. It may be recognized that, upon receiving the feedback, the occupant may elect to further modify the energy consumption request to further optimize the energy consumption. In other words, the occupant may elect to compromise his/her comfort in favor of saving money and/or minimizing ecological footprint by reducing the energy expenditures.

In a possible implementation, the method of FIG. 3 can be performed every time an occupant enters a new energy consumption requirement or revises an energy consumption requirement in order to ensure that the energy consumption requirement does not conflict with the energy consumption rules and to provide feedback to the occupant regarding the energy costs of the energy consumption requirement.

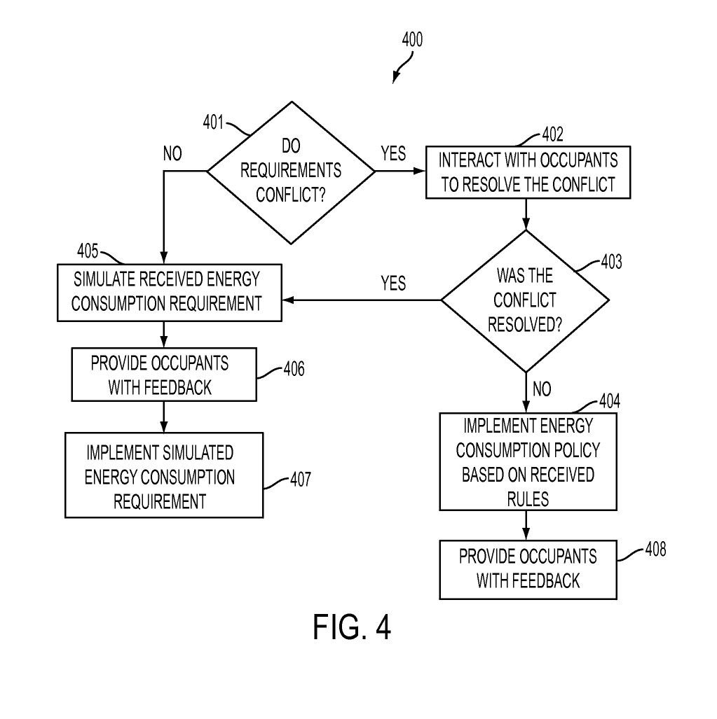

FIG. 4 illustrates a method for conflict resolution between energy consumption requirements entered by two or more occupants, according to an embodiment of the present invention. The method of FIG. 4 can be used in the implementation of step 203 of FIG. 2 in order to resolve conflicts between energy consumption requirements.

At step 401 of the method 400, a determination is made whether an energy consumption requirement received from an occupant conflicts with an energy consumption requirement received from another occupant. If it is determined that there is no conflict, the process 400 proceeds to step 405. If it is determined that there is a conflict, the process 400 proceeds to step 402.

Upon determining that there are conflicting energy consumption requirements, at step 402, the occupants-originators of the conflicting energy consumption requirements are notified about the conflict and prompted to modify respective energy consumption requirements in effort to resolve the conflict. In an embodiment of the present invention, occupants may be notified via HMI 104 or any known information delivery channels (email, text messaging, social media, etc.). In a possible implementation, the occupants can interact to resolve the conflict using the social network social network maintained by the analytical engine 105. In an advantageous embodiment, upon notification about the conflict, all parties to the conflict are prompted to interact with each other, through discussed above available information delivery channels (e.g., HMI, email, social media, text messaging, etc.), in addition to being able to interact with the analytical engine 105 in effort to negotiate mutually acceptable solution.

If, at step 403, it is determined that the conflict is resolved by the occupants involved in the dispute, the system 400 proceeds to step 405, at which the energy consumption policy, formulated based on the energy consumption requirements that resulted from the reached compromise between the occupants, is simulated by the energy simulation software to determine an economic consequence of the energy consumption policy being simulated for each occupant who submitted the energy consumption requirement. One skilled in the art will recognize that the economic consequence may be quantified in estimated financial expenditures, estimated energy expenditures (e.g., KiloWatts (KW) for electricity, BTU for natural gas/propane, tons for coal, etc.), and ecological footprint, but the present invention is not intended thereto. According to an advantageous embodiment, the estimated economic consequence of simulated energy consumption policy is also determined for the building.

According to an embodiment of the present invention, simulation of the energy consumption requirements is invoked each time the occupant submit a new energy consumption requirement by adjusting the set points on his/her HMI.

Upon determining the economic consequence of the energy consumption policy for each occupant and the building, at step 406, the occupants, who submitted their respective energy consumption requirements, are provided with feedback in the form of data containing the economic consequence to each occupant who submitted the energy consumption requirement. According to an advantageous embodiment, the feedback may include one or more suggestions to the occupant on how to further optimize their respective energy consumption. Upon receiving the feedback, each occupant may elect to further modify the energy consumption request to further optimize the energy consumption. In other words, each or some of the occupants may elect to compromise their comfort in favor of saving money and/or minimizing ecological footprint by reducing the energy expenditures.

Following step 406, at step 407, the energy consumption requirements are implemented at the BAS of the building. According to an advantageous embodiment, implemented energy consumption policy is being continuously or periodically monitored and gathered data is being provided to the occupant and to the facility manager.

Returning to step 403, if a determination is made that the conflict between the energy consumption requirement and energy consumption rule is not resolved, the process 400 proceeds to step 404, at which the energy consumption policy is formulated based an energy consumption rule provided by the facility manager and implemented in the BAS 106.

It is to be understood that the energy consumption policy is formulated by automatically resolving the conflict between the energy consumption requirements based on specifications in the energy consumption rules provided by the facility manager. For example, one of the two conflicting energy consumption requirements can be selected based on some specified rules (e.g., least energy cost, first in time priority, auction rules with energy credits) or a compromise can be forced by revising both of the conflicting energy consumption requirements until they no longer conflict.

Then the method 400 proceeds to step 408, where the occupants who originated the energy consumption requirements are provided with feedback. According to an embodiment, the feedback may include explanation why the occupants' energy consumption requirements were not implemented. The feedback may also include a comparison of the economic benefit to occupants from implementing the energy consumption rule over implementing occupants' energy consumption requirements. It may be recognized that, upon receiving the feedback, each occupant may elect to further modify the energy consumption request to further optimize the energy consumption. In other words, each occupant may elect to compromise his/her comfort in favor of saving money and/or minimizing ecological footprint by reducing the energy expenditures.

In a possible embodiment, simulation of the energy consumption requirements is conducted upon initial engineering implementation of the system 100 of FIG. 1. During this simulation, the mappings between occupants' possible variations of the energy consumption requirements are captured in a lookup table. Upon receiving occupant's energy consumption requirement (e.g., detection of the adjustment of energy consumption controls), analytical engine 105 of FIG. 1 estimates energy consumption using the lookup table.

In an exemplary embodiment of the present invention, the energy consumption rules, entered by facility managers, may include justification for the energy consumption rules, energy consumption costs distribution among occupants, and pre-defined guidelines for a conflict resolution in case of conflicting energy consumption requirements among occupants. Also, the energy consumption rules may include an assignment of a number of energy credits to each occupant so that occupants could spend these energy credits to request the energy consumption requirements. For example, occupants who insist on higher comfort standard may be obligated to pay more energy credits.

In an embodiment of the present invention, several options of conflict resolution may be provided by the energy consumption rules. For example, a conflict may be settled by invoking an auction option in which the auction model may include one or more bidding formulae. In another example, a conflict may be resolved by a pre-defined rule that instructs occupants to split energy costs as even as possible. The following example is one of the exemplary embodiments that may be utilized by the system 100 of FIG. 1. The facility manager may enter the following general energy consumption rules of the building. Including:
Each occupant got assigned certain energy credit due to company policies.
The company covers refrigerators from 9 am to 1 pm in weekdays to accommodate those who bring their lunch. There is Spike's justifications that he posted on his social network personal page at the system: As a comparison, without the system, the company needs to pay the fridge energy bill 24×7, usually including weekends and holidays. With the system, the company may pay just 4 hr per workday, or only 12% of previous energy use. This policy can reduce X kg CO2 and save $Y per year.
The organizer of a meeting is responsible for the corresponding energy bill.
When occupants have conflictive Requirements, try to settle the confliction follow an auction model with certain formula. The occupant who insist higher comfort standard is obligated to pay more energy credit.
Other energy costs are split as even as possible.

In the following exemplary embodiment, utilization of the system 100 of FIG. 1 by two occupants of a building is illustrated.

Tom and Jerry have only rudimentary computer skills with no programming backgrounds. Tom tells the system his routine schedule via Outlook Calendar. His office hour is 9 am to 1 pm, then 2 pm to 6 pm. He plans to have lunch from 1 pm to 2 pm at office. Once he types in this schedule, he got a notice from the system saying that due to Spike's policy, “all occupants need to pay 1 credit per day for the fridge to operate between 1 pm to 2 pm.” Tom's first response is to find Jerry to share the costs, so that he can pay just 0.5 credits per day. However, from the system social network, Tom found Jerry's lunch hour is 12 am to 1 pm, and he said Spike's blog. Tom decides to shift his lunch time the same as Jerry, to save credits and save the earth. Since no one books the fridge after 1 pm, the BAS shut off the fridge at the time. Next, Tom books a meeting room for a discussion with Jerry from 10 am to 11 am. The Planer told Tom that the estimated energy bill is 1 credit. He can choose “close end” or “open end” for the meeting. He selects “close end,” which means the light will be shut off at 11 am and his billing period stops at 11 am. Tom cannot turn on the light afterward unless he books the room again. At 10 am, Tom entered the conference room, where the temperature is already adjusted to Tom's preference. He turned on the light, had a 30 min discussion with Jerry, then manually shut down the light and HAVC. Later, both Tom and Spike get notice from the system that the meeting saved 0.5 credits. Tom decides to post the message on his social network homepage. In the afternoon, Tom and Jerry have an appointment on an important phone conference with a client from 2 pm to 3 pm. Tom reserved the conference room as “open end.” The meeting was actually finished at 3:30 pm, but the light was not automatically shut off at 3 pm. Tom and Spike were noticed afterward that Tom was billed 1.5 credits. Tom did not post the message on his social network. At 6 pm, Tom went home, but he forgot to shut off his computer and his desk lamp. The system automatically shut off the devices since Tom did not request to keep the electricity. Sometimes, Tom needs to run his computer over night. He needs to book the time. Tom shares his office with Jerry, who reserves office hour from 8 am to 12 am and 1 pm to 5 pm. The ambient light and HVAC bill is split into three slots: Jerry pays 8 am to 9 am; Tom pays 5 pm to 6 pm; they share at the rest time. Due to Spike's inputs, Jerry has authority to turn on Tom's desk lamp from 8 am to 9 am, if Jerry books the time and, therefore, agrees to pay associated costs. Jerry does not have the authority to turn on the lamps in Spike's office at the time slot, even if Jerry is willing to pay.

In yet another exemplary embodiment, utilization of the system 100 of FIG. 1 for hybrid (e.g., HVAC system) control by two occupants of a building is illustrated.

Some facilities are intrinsically associated with continuous physical phenomena, therefore cannot be judged by binary logics. For example, HVAC system is coupled with thermal dynamics. Motorized windows, blinds, AHU, and other thermal systems are also within this category. It is more challenging to define the Specifications for hybrid control. After simulations, Spike typed in these rules
The company pays 68° F. to 70° F. for winter. Occupants can pay credits for higher temperature and get incentives for lower temperature.
The company pays 75° F. to 77° F. for summer Occupants can pay credits for lower temperature and get incentives for higher temperature.
Compromise rule: In case of conflicts, first try averaging set points.
Market rule: Conflictions are settled by auction.
. . .
   Tom and Jerry are within the same thermal zone. Tom is next to a motorized window with motorized blinds. Jerry is not close to any window. Each of them has a radiant ceiling (RC) on top of their desk. In normal winter days, Tom and Jerry prefer 68° F. and 70° F., respectively. After simulation, the Analyzer confirmed that the BAS is capable to maintain 2° F. temperature difference within the zone, therefore there is no confliction. One day, Jerry feels cold and he prefers to go 72° F. at 8:00 am, when Tom is not in the office. The temperature reaches 72° F. soon and Jerry pays as the rate defined by Spike. At 9 am, Tom's office hour starts. Due to Spike's rule, the temperature at Tom and Jerry's desks are adjusted to 69° F. and 71° F., respectively. If Jerry insists on 72° F., he can pay Tom credits for scarifying his comfort level. Just like on a free market, Tom can either accept the offer or pay Jerry to reduce 1° F. The detailed rate is defined by Spike, who has the responsibility to ensure the auction policy is appropriate. The Rule Helper can interface with the Arbitrator and the Analyzer to assistant Spike's work.

It is to be understood that similar concept is applicable to natural illumination and ventilation systems. All the data are rendered on their social network page interactively. They can track their energy usage, analyze the cause, and compare with other people's performances. The different behaviors of Tom and Jerry visually highlighted. They can exchange tips on how to save energy. For instance, Tom may tag his Requirements “cozy winter” and share it with Jerry, who may incorporate it into his personal Requirements.

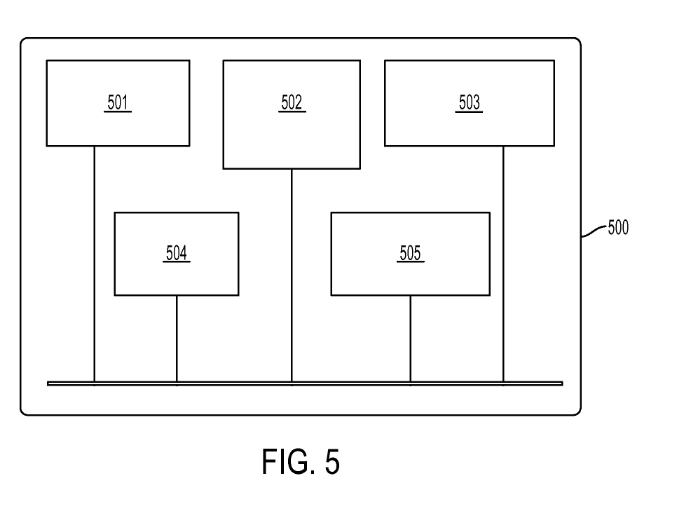

The above-described methods for energy efficient building control for commercial buildings can be implemented on a computer using well-known computer processors, memory units, storage devices, computer software, and other components. A high level block diagram of such a computer is illustrated in FIG. 5. Computer 500 contains a processor 501 which controls the overall operation of the computer 500 by executing computer program instructions which define such operation. The computer program instructions may be stored in a storage device 502 (e.g., magnetic disk) and loaded into memory 503 when execution of the computer program instructions is desired. Thus, applications for performing the method steps of FIGS. 2, 3, and 4 can be defined by the computer program instructions stored in the memory 503 and/or storage 502 and controlled by the processor 504 executing the computer program instructions. The computer 500 also includes one or more network interfaces 504 for communicating with other devices via a network. The computer 500 also includes other input/output devices 505 that enable user interaction with the computer 500 (e.g., display, keyboard, mouse, speakers, buttons, etc.)

One skilled in the art will recognize that an implementation of an actual computer or computer system may have other structures and may contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for energy efficient collaborative high performance building control comprising:
receiving, from a first user, at least one energy consumption requirement;
determining whether the at least one energy consumption requirement conflicts with an energy consumption ruleset;
determining whether the at least one energy consumption requirement conflicts with another energy consumption requirement received from a second user; and
simulating the at least one energy consumption requirement.

2. The method of claim 1, further comprising:
receiving the energy consumption ruleset from a facility manager of the building.

3. The method of claim 1, further comprising:
estimating at least one metric of energy consumption for the at least one energy consumption requirement based on the simulation of the at least one energy consumption requirement.

4. The method of claim 3, wherein estimating the at least one metric of energy consumption comprises:
calculating a cost of the energy consumption based on the simulation of the at least one energy consumption requirement.

5. The method of claim 1, further comprising:
controlling a building automation system (BAS) to implement the at least one energy consumption requirement.

6. The method of claim 1, further comprising:
providing feedback of estimated energy consumption based on the simulation of the at least one energy consumption requirement to the first user.

7. The method of claim 6, further comprising:
providing, to the first user, at least one suggestion for revising the at least one energy consumption requirement based on the simulation of the at least one energy consumption requirement.

8. The method of claim 6, wherein providing feedback of the estimated energy consumption of the at least one energy consumption requirement comprises:
displaying a calculated cost of the energy consumption of the at least one energy consumption requirement via a graphical user interface; and
prompting the first user to modify the at least one energy consumption requirement via the graphical user interface.

9. The method of claim 6, wherein the first user is a first occupant of the building,
the second user is a second occupant of the building, and
an originator of the energy consumption ruleset is a facility manager of the building.

10. The method of claim 1, further comprising:
in response to determining that the at least one energy consumption requirements conflicts with the energy consumption ruleset, prompting the first user to modify the at least one energy consumption requirement to resolve the conflict with the energy consumption ruleset.

11. The method of claim 1, further comprising:
in response to determining received that the at least one energy consumption requirement conflicts with another energy consumption requirement:
prompting the first and second users to resolve the conflict between the respective energy consumption requirements.

12. The method of claim 11, further comprising:
maintaining a social network to enable the first and second users to communicate to resolve the conflict between the respective energy consumption requirements.

13. The method of claim 1, further comprising:
in response to determining received that the at least one energy consumption requirement conflicts with another energy consumption requirement:
automatically resolving the conflict between the respective energy consumption requirements based on specifications included in the energy consumption ruleset.

14. An apparatus for energy efficient collaborative high performance building control comprising:
means for receiving, from a first user, at least one energy consumption requirement;
means for determining whether the at least one energy consumption requirement conflicts with an energy consumption ruleset;
means for determining whether the at least one energy consumption requirement conflicts with another energy consumption requirement received from a second user; and
means for simulating the at least one energy consumption requirement.

15. The apparatus of claim 14, further comprising:
means for receiving the energy consumption ruleset from a facility manager of the building.

16. The apparatus of claim 14, further comprising:
means for estimating at least one metric of energy consumption for the at least one energy consumption requirement based on the simulation of the at least one energy consumption requirement.

17. The apparatus of claim 16, wherein the means for estimating the at least one metric of energy consumption comprises:
means for calculating a cost of the energy consumption based on the simulation of the at least one energy consumption requirement.

18. The apparatus of claim 14, further comprising:
means for controlling a building automation system (BAS) to implement the at least one energy consumption requirement.

19. The apparatus of claim 14, further comprising:
means for providing feedback of estimated energy consumption based on the simulation of the at least one energy consumption requirement to the first user.

20. The apparatus of claim 19, further comprising:
means for providing, to the first user, at least one suggestion for revising the at least one energy consumption requirement based on the simulation of the at least one energy consumption requirement.

21. The apparatus of claim 19, wherein the means for providing feedback of the estimated energy consumption of the at least one energy consumption requirement comprises:
means for displaying a calculated cost of the energy consumption of the at least one energy consumption requirement via a graphical user interface; and
means for prompting the first user to modify the at least one energy consumption requirement via the graphical user interface.

22. The apparatus of claim 19, wherein the first user is a first occupant of the building,
the second user is a second occupant of the building, and
an originator of the energy consumption ruleset is a facility manager of the building.

23. The apparatus of claim 14, further comprising:
means for prompting the first user to modify the at least one energy consumption requirement to resolve the conflict with the energy consumption ruleset, in response to determining that the at least one energy consumption requirements conflicts with the energy consumption ruleset.

24. The method of claim 14, further comprising:
in response to determining received that the at least one energy consumption requirement conflicts with another energy consumption requirement:
prompting the first and second users to resolve the conflict between the respective energy consumption requirements.

25. The method of claim 24, further comprising:
maintaining a social network to enable the first and second users to communicate to resolve the conflict between the respective energy consumption requirements.

26. The method of claim 14, further comprising:
in response to determining received that the at least one energy consumption requirement conflicts with another energy consumption requirement:
automatically resolving the conflict between the respective energy consumption requirements based on specifications included in the energy consumption ruleset.

27. A non-transitory computer readable medium storing computer program instructions for energy efficient collaborative high performance building control, the computer program instructions, when executed, cause a processor to perform a method comprising:
receiving, from a first user, at least one energy consumption requirement;
determining whether the at least one energy consumption requirement conflicts with an energy consumption ruleset;
determining whether the at least one energy consumption requirement conflicts with another energy consumption requirement received from a second user; and
simulating the at least one energy consumption requirement.

28. The non-transitory computer readable medium of claim 27, further comprising:
receiving the energy consumption ruleset from a facility manager of the building.

29. The non-transitory computer readable medium of claim 27, further comprising:
estimating at least one metric of energy consumption for the at least one energy consumption requirement based on the simulation of the at least one energy consumption requirement.

30. The non-transitory computer readable medium of claim 29, wherein estimating the at least one metric of energy consumption comprises:
calculating a cost of the energy consumption based on the simulation of the at least one energy consumption requirement.

31. The non-transitory computer readable medium of claim 27, further comprising:
controlling a building automation system (BAS) to implement the at least one energy consumption requirement.

32. The non-transitory computer readable medium of claim 27, further comprising:
providing feedback of estimated energy consumption based on the simulation of the at least one energy consumption requirement to the first user.

33. The non-transitory computer readable medium of claim 32, further comprising:
providing, to the first user, at least one suggestion for revising the at least one energy consumption requirement based on the simulation of the at least one energy consumption requirement.

34. The non-transitory computer readable medium of claim 32, wherein providing feedback of the estimated energy consumption of the at least one energy consumption requirement comprises:
displaying a calculated cost of the energy consumption of the at least one energy consumption requirement via a graphical user interface; and
prompting the first user to modify the at least one energy consumption requirement via the graphical user interface.

35. The non-transitory computer readable medium of claim 32, wherein the first user is a first occupant of the building,
the second user is a second occupant of the building, and
an originator of the energy consumption ruleset is a facility manager of the building.

36. The non-transitory computer readable medium of claim 27, further comprising:
in response to determining that the at least one energy consumption requirements conflicts with the energy consumption ruleset, prompting the first user to modify the at least one energy consumption requirement to resolve the conflict with the energy consumption ruleset.

37. The non-transitory computer readable medium of claim 27, further comprising:
in response to determining received that the at least one energy consumption requirement conflicts with another energy consumption requirement:
prompting the first and second users to resolve the conflict between the respective energy consumption requirements.

38. The non-transitory computer readable medium of claim 37, further comprising:
maintaining a social network to enable the first and second users to communicate to resolve the conflict between the respective energy consumption requirements.

39. The non-transitory computer readable medium of claim 27, further comprising:
in response to determining received that the at least one energy consumption requirement conflicts with another energy consumption requirement:
automatically resolving the conflict between the respective energy consumption requirements based on specifications included in the energy consumption ruleset.
